(19) United States
(12) Patent Application Publication
(10) Pub. No.: US 2015/0131705 A1
(43) Pub. Date: May 14, 2015

(54) MODULATION SCHEME FOR COMMUNICATION

(71) Applicant: Analog Devices Technology, Hamilton (BM)

(72) Inventors: Haim Primo, Ganei Tikva (IL); Yosef Stein, Sharon, MA (US); Oz Gabai, Tel Aviv (IL)

(73) Assignee: Analog Devices Technology, Hamilton (BM)

(21) Appl. No.: 14/213,561

(22) Filed: Mar. 14, 2014

Related U.S. Application Data
(60) Provisional application No. 61/902,019, filed on Nov. 8, 2013.

(51) Int. Cl. H04B 1/707

(52) U.S. Cl. CPC H04B 1/707
USPC 375/146

(57) ABSTRACT

A modulation scheme for long range transceiver utilizing a processing scheme in combination with a Hadamard transform is disclosed. The processing scheme can correspond to an industry standard or to other processing schemes. An input signal is parallelized through serial to parallel conversion. The processed parallel signals are orthogonalized using a Hadamard transform to allow multiple channel signals with increased throughput. Accordingly, the long range modulation scheme of this invention can achieve high efficiency and increased throughput while meeting performance goals of long range signal transmission.

### CROSS-REFERENCE TO RELATED APPLICATION

This application claims the benefit under 35 U.S.C. §119(e) of U.S. Provisional Application No. 61/902,019, filed Nov. 8, 2013, the entirety of which is hereby incorporated by reference.

### BACKGROUND

1. Field of the Invention

The invention generally relates to electronics. In particular, the invention relates to modulation for communication.

2. Description of the Related Art

Long range receivers, transmitters, receiver/transmitters, and transceivers used in a system such as a smart grid benefit from a certain level of sensitivity. However, long range modulation schemes often are proprietary and not compliant with the IEEE industry standard, such as the 802.15.4g specification.

### SUMMARY

The systems, methods, and devices of the invention each have several aspects, no single one of which is solely responsible for its desirable attributes.

One embodiment includes an apparatus comprising a serial-to-parallel converter configured to allocate symbols of a first signal among a plurality of parallel signals and a long-range spreader configured to generate a long-range spread signal, wherein the long-range spreader is a plurality of direct sequence spread spectrum (DSSS) encoders extended by an orthogonal transform.

One embodiment includes an electronically-implemented method of signal processing, the method comprising allocating symbols of a first signal among a plurality of parallel signals, direct sequence spreading the plurality of parallel signals to generate a plurality of spread signals, and orthogonalizing the plurality of spread signals to generate an orthogonalized output.

One embodiment includes an apparatus for signal processing, the apparatus comprising a serial-to-parallel converter configured to allocate symbols of a first signal among a plurality of parallel signals, a plurality of direct sequence spread spectrum (DSSS) encoders configured to generate a plurality of spread signals in parallel, and a means for orthogonalizing the plurality of spread signals to generate an orthogonalized output.

### BRIEF DESCRIPTION OF THE DRAWINGS

These drawings and the associated description herein are provided to illustrate specific embodiments of the invention and are not intended to be limiting.

FIG. 1 is a block diagram illustrating a modulation scheme.

FIG. 2 is a block diagram illustrating a spreading process.

FIG. 3 is a block diagram illustrating a modulation scheme according to an embodiment.

FIG. 4 is a block diagram showing a modified direct sequence spread spectrum (DSSS) modulation path.

FIG. 5A is a graph illustrating gain for single-channel DSSS processing.

FIG. 5B is a graph illustrating gain for modified multi-channel DSSS processing.

FIG. 6 is a graph showing rate performance of an embodiment.

### DETAILED DESCRIPTION OF CERTAIN EMBODIMENTS

Long-range modulation schemes with low sensitivity are desirable for systems such as a smart grid. Currently available long range modulation technologies often implement proprietary schemes which do not include the standardized processes defined in an industry standard specification, such as IEEE 802.15.4g. Moreover, some long range modulation technologies that are currently available address only narrow band signals, which may pose limitations to the applicability of the technology.

Various embodiments disclosed herein address the code inefficiencies raised by propriety long range modulation schemes and the limited application of narrow band long range modulation schemes by utilizing spreading schemes while increasing throughput by creating multiple orthogonal channels using the vectors of an orthogonal transform such as the Hadamard matrix. In certain embodiments, the spreading schemes can correspond to industry standard spreading schemes. However, in alternative embodiments, different spreading schemes can be used, including those yet to be developed.

One non-limiting embodiment includes an orthogonal parallel multi-channel processing route in addition to a direct sequence spread spectrum (DSSS) and/or multiplexed direct sequence spread spectrum (MDSSS) routes. The additional processing route can convert the signal from serial to parallel, use a DSSS coding and spreading scheme, and create multiple orthogonal channels using orthogonal vectors of a Hadamard matrix. Since DSSS coding and spreading can be used for operation of more than one modulation technology, this embodiment can reuse the DSSS coding and spreading scheme while increasing the throughput by orthogonally parallelizing the signal.

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect. For example, an apparatus may be implemented or a method may be practiced using any number of the aspects set forth herein. In addition, the scope is intended to cover such an apparatus or method which is practiced using other structure, functionality, or structure and functionality in addition to or other than the various aspects set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different data access technologies, system configurations, networks, and transmission protocols, some of which are illustrated by way of example in the figures and in the following description. The detailed description and drawings are merely illustrative of the disclosure rather than limiting.

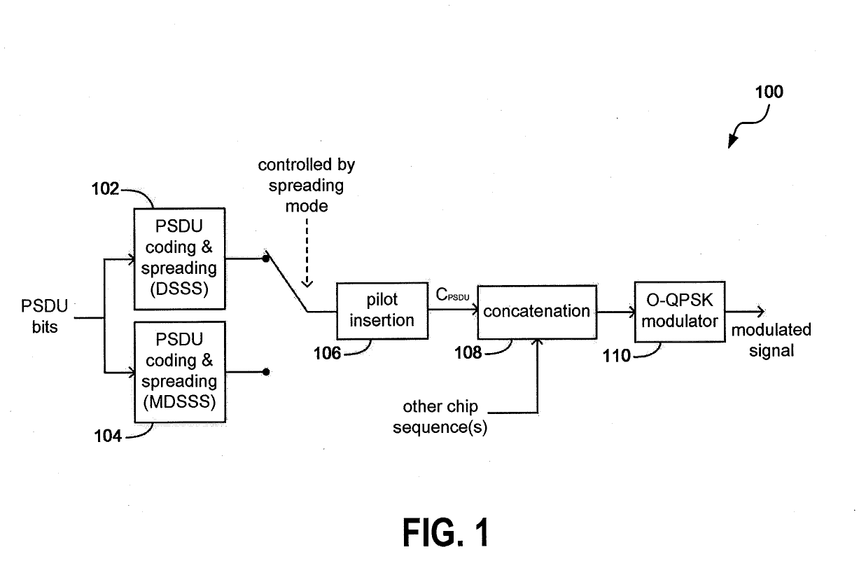

FIG. 1 is a block diagram showing a modulation scheme 100 according to the IEEE 802.15.4g specification. The modulation scheme 100 involves taking the input physical layer data service unit (PSDU) bits and processing through either a direct sequence spread spectrum (DSSS) coding and spreading block 102 or a multiplexed direct sequence spread spectrum (MDSSS) coding and spreading block 104. While illustrated using “blocks,” the blocks described herein can be readily implemented by one of ordinary skill in the art using hardware and/or software/firmware. The selection between the DSSS coding and spreading block 102 and the MDSSS coding and spreading block 104 is determined by the spreading mode. A pilot signal can be inserted at a pilot insertion block 106, and the pilot insertion block 106 generates a modified PSDU chip sequence C_{PSDU} as an output. The PSDU chip sequence can then be concatenated with other chip sequences at a concatenation block 108. Afterwards, the concatenated signal goes through an offset quadrature phase-shift keying (O-QSPK) modulator block 110, which generates a modulated signal as an output.

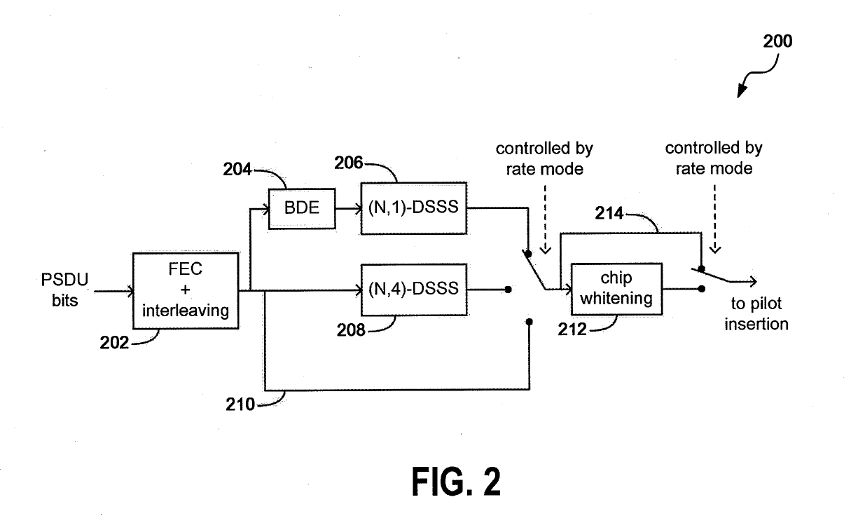

FIG. 2 is a block diagram showing a spreading process 200 according to the IEEE 801.15.4g specification. The spreading process 200 illustrated in FIG. 2 has its spreading mode set to DSSS as in the DSSS coding and spreading block 102 in FIG. 1. The input PSDU bits are processed by a forward error correction (FEC) and interleaving block 202, and the output of the FEC and interleaving block 202 is directed to a selected path based on the rate mode. One path includes a bit differential encoding (BDE) block 204 and a (N,1)-DSSS encoder 206. Another path includes a (N,4)-DSSS encoder 208 without a BDE block. Another path 210 bypasses BDE and DSSS processing. Output from one of these paths, then may go through the chip whitening block 212 or may bypass the chip whitening block 214 depending on the selected rate mode. Then the resulting signal is passed on to the pilot insertion block 106 of FIG. 1.

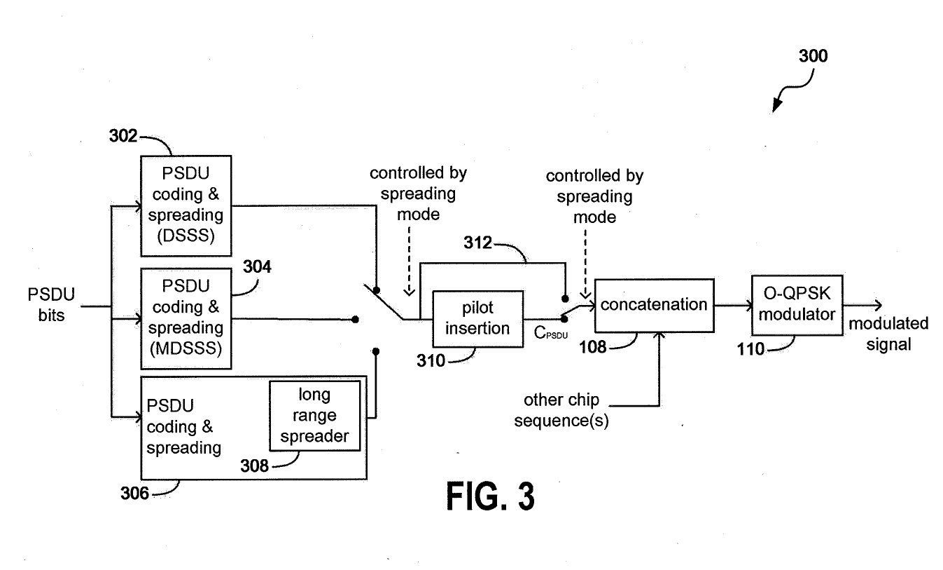

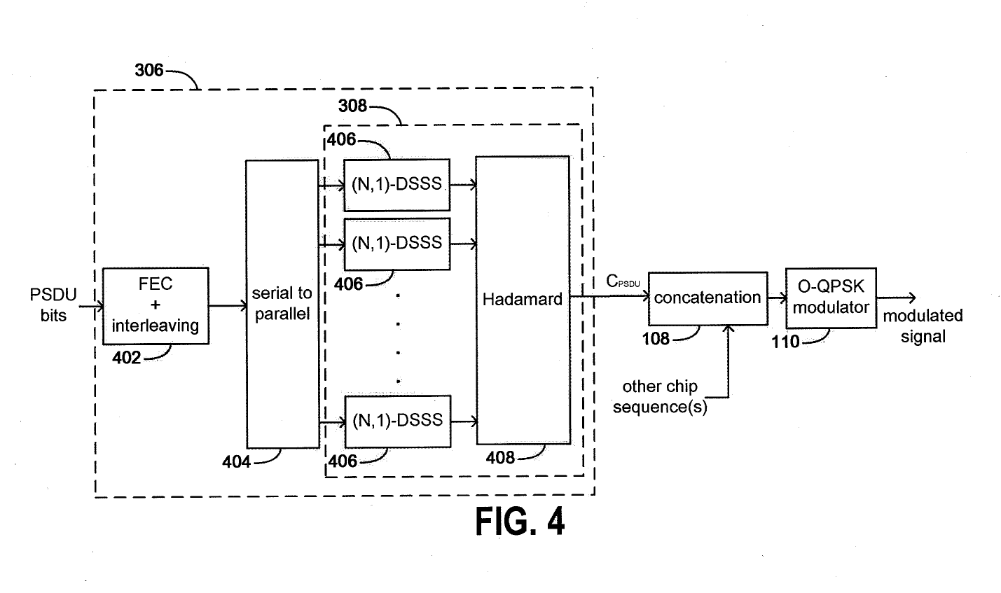

FIG. 3 is a block diagram illustrating a modulation scheme 300 according to an embodiment. The modulation scheme 300 includes a DSSS encoder 302, a MDSSS encoder 304, a modified DSSS encoder 306, and a long-range spreader 308. The PSDU bits are processed according to the selected spreading mode. The input PSDU bits can be processed through a selected one of (a) the DSSS encoder 302, (b) the MDSSS encoder 304, or (c) the modified DSSS encoder 306, which includes the long-range spreader 308. The long range-spreader 308 can include one or more spreaders followed by an orthogonal transform such as the Hadamard transform to extend the spreading code. In the illustrated embodiment, the modified DSSS encoder 306 can utilize the standard DSSS coding and spreading scheme for parallelized signals and will be described in greater detail later in connection with FIG. 4. The selection of these different paths is controlled by the spreading mode, and the output from the selected coding and spreading scheme either proceeds to a pilot insertion block 310 or bypasses 312 the pilot insertion block 310 when the path with the modified DSSS encoder 306 and the long-range spreader 308 is selected. A modified PSDU chip sequence C_{PSDU} output of the pilot insertion block 310 or the long-range spreader 308 is provided as an input to the concatenation block 108, which generates a concatenated signal, and the concatenated signal is provided as an input to the O-QPSK modulator block 110 to generate a modulated signal as an output.

FIG. 4 is a block diagram illustrating additional details of a modified DSSS modulation path of the modified modulation scheme 300 of FIG. 3. The block diagram illustrates the modified DSSS encoder 306, which includes the long-range spreader 308, in greater detail. In the illustrated embodiment, the modified DSSS encoder 306 includes a FEC and interleaving block 402, a serial-to-parallel converter 404, and the long range spreader 308. The long-range spreader 308 includes and a plurality of (N,1)-DSSS encoders 406 and an Hadamard transform signal processor 408. In another embodiment, a different type of orthogonal transform signal processor can be used instead of the Hadamard transform signal processor 408. The input PSDU bits are processed through the FEC and interleaving block 402 to generate an interleaved signal. The interleaved signal proceeds to the serial-to-parallel converter 404 to distribute or allocate the symbols of the interleaved signal among a plurality of parallel signal paths. For example, the serial-to-parallel converter 404 can be implemented by one or more shift registers and can convert a serial data stream to a parallel data stream. Each signal path of the parallel signal paths from the serial-to-parallel converter 404 is processed through a (N,1)-DSSS encoder 406 to generate a spread signal.

Each of the (N,1)-DSSS encoders 406 can be, for example, the same as the (N,1)-DSSS encoder 206 described earlier in connection with FIG. 2. Each of the resulting spread signals is then processed through the orthogonal transform signal processor 408 to be orthogonalized, that is, orthogonal with respect to each other. The modified PSDU chip sequence C_{PSDU} output from the orthogonal transform signal processor 408 is then processed through a concatenation block 108 to generate a concatenated signal, and the concantenated signal is processed through the O-QPSK modulator block 110 to produce a modulated signal.

The long-range spreader 308 outputs a long-range spread signal that is spread in parallel and subsequently orthogonalized and advantageously increases system sensitivity and range. In one embodiment, a signal processor similar to the long-range spreader 308 is configured to apply an orthogonal transform to the plurality of spread signals discussed above. The number of the plurality of spread signals through the (N,1)-DSSS encoders 406 and the size of the orthogonal transform of the orthogonal transform signal processor 408 can be selected to increase sensitivity and range. For example, for a 125 kHz bandwidth (BW) channel with a basic spreading factor (SF) of 32 and noise floor (NF) of 4.5 dB, the receiver sensitivity can be calculated as follows:

$$\begin{matrix}Sensitivity = - Thermal Noise - ( - 10 {log}_{10} ( BW ) - NF + 10 log ( SF ) ) \\ = - 174 - ( - 10 log ( 125 kHz ) - 4.5 + 10 log ( 32 ) \\ = - 133.5 .5 dBm\end{matrix}$$

The long-range spreader 308 with an effective spreading factor (SF) of, for example, 3200 can be implemented by using a basic code, such as (N,1)-DSSS, extended by a M 100 sub-Hadamard matrix with M=8, i.e., 8 parallel channels within the long-range spreader 308. The receiver sensitivity for the same receiver as above can be calculated as follows:

$$\begin{matrix}Sensitivity = - Thermal Noise - ( - 10 {log}_{10} ( BW ) - NF + 10 log ( SF / M ) ) \\ = - 174 - ( - 10 log ( 125 Khz ) - 4.5 + 10 log ( 3200 / 8 ) \\ = - 144.5 dBm .\end{matrix}$$

In the illustrated embodiment, orthogonalizing the parallel spread signals by the Hadamard transform signal processor 408 is achieved by multiplying different spreading sequences with orthogonal vectors from a Hadamard matrix. In other embodiments, alternative orthogonal matrices can be used. In various embodiments, orthogonalized signals can be created given the input bits, a spreading sequence of C={c[0], c[1] . . . c[N−1]}, and a 4×4 Hadamard matrix of:

$$[ \begin{matrix}1 & - 1 & - 1 & 1 \\ 1 & 1 & - 1 & - 1 \\ 1 & - 1 & 1 & - 1 \\ 1 & 1 & 1 & 1\end{matrix} ]$$

A subset of two vectors from the Hadamard matrix, such as [1 −1 1 1] and [1 1 −1 −1] may be chosen. Using the chosen subset, two bit values of

$$\frac{{b}_{0}}{\sqrt{2}}$$

$$and$$

$$\frac{{b}_{1}}{\sqrt{2}}$$

can be sent such that:

$$y = \frac{{b}_{0}}{\sqrt{2}} \{ C , - C , - C , C \} + \frac{{b}_{1}}{\sqrt{2}} \{ C , C , - C , - C \} = y = \frac{{b}_{0}}{\sqrt{2}} \{ c [ 0 ] … c [ N - 1 ] , - c [ 0 ] … - c [ N - 1 ] , - c [ 0 ] … - c [ N - 1 ] , c [ 0 ] … c [ N - 1 ] \} + \frac{{b}_{0}}{\sqrt{2}} \{ c [ 0 ] … c [ N - 1 ] , c [ 0 ] … c [ N - 1 ] , - c [ 0 ] … - c [ N - 1 ] , - c [ 0 ] … - c [ N - 1 ] \}$$

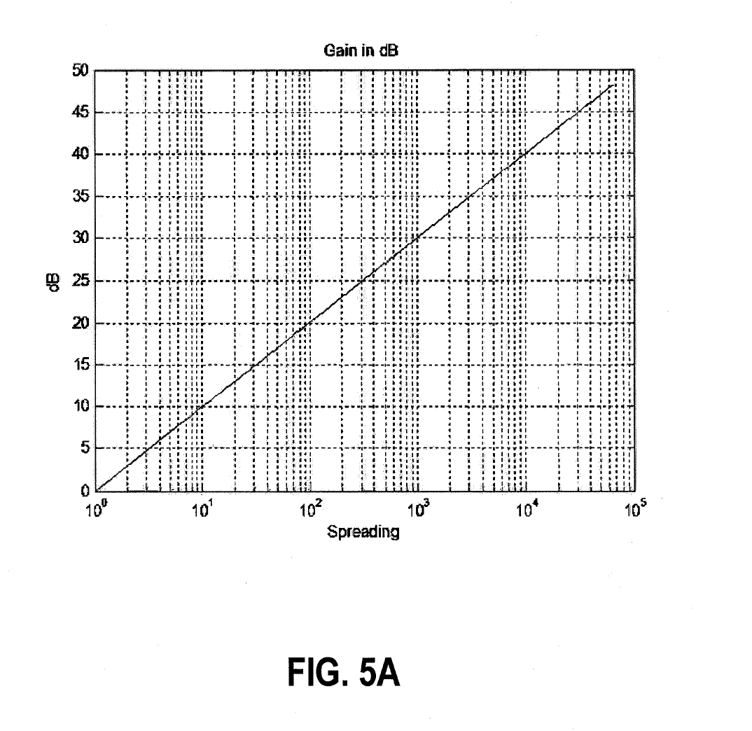

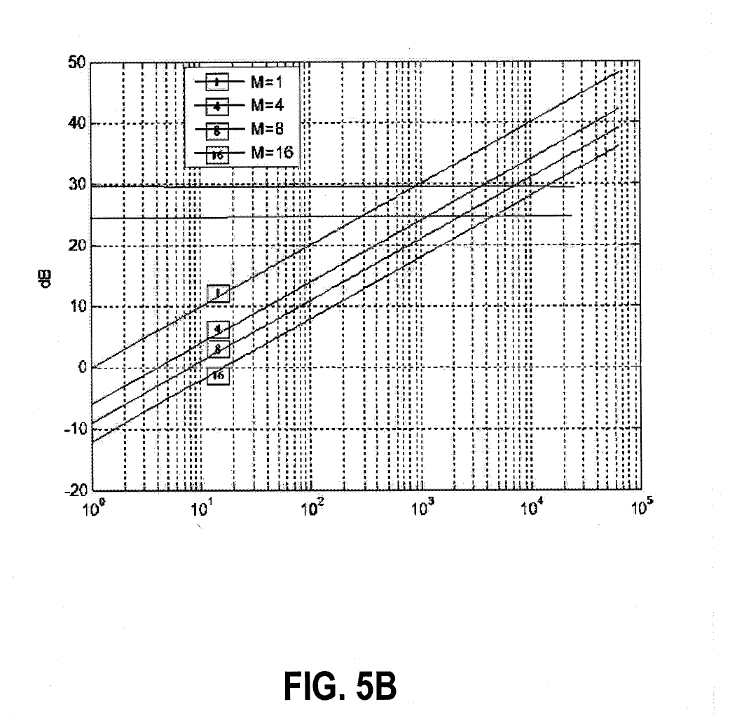

FIG. 5A is a graph of simulation results of a single channel DSSS gain. The graph shows a single channel DSSS gain over a range of spreading factors. The horizontal axis represents spreading factor, and the vertical axis represents gain from the DSSS encoder 102 (FIG. 1). Assuming N chips per symbol and binary phase shift keying (BPSK), the DSSS gain can be determined as below. If rx[n]=bc[n]+v[n] where c is the code with +/−1 and length of N and b is the bit value, performing de-spread will give:

$$\begin{matrix}\hat{b} = \frac{1}{N} {\sum }_{n = 0}^{N - 1} rx [ n ] c [ n ] \\ = b + \frac{1}{N} \sum c [ n ] v [ n ]\end{matrix}$$

$$var \{ \frac{1}{N} \sum c [ n ] v [ n ] \} = \frac{1}{N} {σ}_{c}^{2}$$

$$DSSS\_gain = 10 {log}_{10} ( N )$$

FIG. 5B is a graph of simulation results of the modified multi-channel DSSS gain. The graph shows how certain parameters can be chosen to design the modified multi-channel DSSS block and the Hadamard transform block. The horizontal axis represents spreading factor, and the vertical axis represents gain from the Hadamard transform block. Assuming M parallel channels, where M is two or more, each with different spreading sequence, and each orthogonal to one another, the modified multi-channel DSSS gain can be determined as shown below. If

$$rx [ n ] = {\sum }_{m = 0}^{M - 1} \frac{{b}_{m}}{\sqrt{M}} {c}_{m} [ n ] + v [ n ]$$

where cₘ is the code with +/−1 and length of N, bₘ is the bit value, and

$${\sum }_{n = 0}^{M - 1} {c}_{q} [ n ] {c}_{s} [ n ] = \{ \begin{matrix}0 , & for q \neq s \\ N , & for q = s\end{matrix} ,$$

performing de-spread will give:

$$\begin{matrix}{\hat{b}}_{s} = \frac{\sqrt{M}}{N} {\sum }_{n = 0}^{N - 1} rx [ n ] {c}_{s} [ n ] \\ = {b}_{s} + \frac{\sqrt{M}}{N} \sum c [ n ] v [ n ]\end{matrix}$$

$$var \{ \frac{1}{N} \sum c [ n ] v [ n ] \} = \frac{M}{N} {σ}_{c}^{2}$$

$$DSSS\_gain = 10 {log}_{10} ( N / M )$$

Referring still to FIG. 5B, the graph shows various modified multi-channel DSSS gains according to a calculation similar as the one above with the value for M ranging from 1 to 16. From the graph, it can be observed that for a given M, a desired gain can be achieved by selecting an appropriate spreading factor and size of the Hadamard matrix.

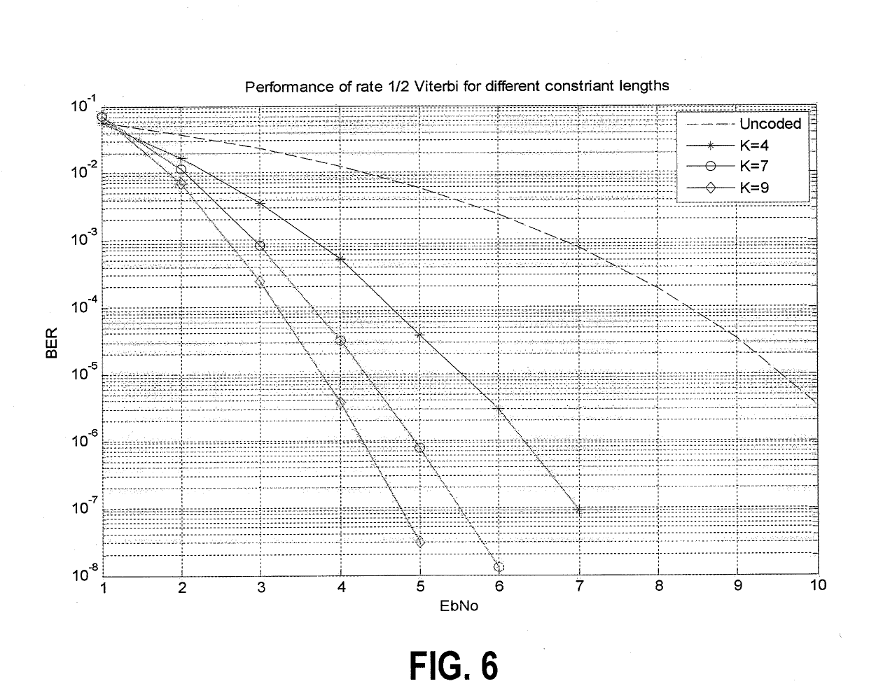

FIG. 6 is a graph showing simulation results of rate performance of M parallel channels with different constrain lengths K as implemented according to one embodiment. The horizontal axis represents signal to noise ratio (SNR) per bit, and the vertical axis represents bit error rate (BER). For the purpose of the plot, rate ½ Viterbi, low noise amplifier (LNA) noise figure of 4.5 decibels (dB), bandwidth of 125 kilohertz (kHz), and block size of 8 bytes are assumed. In this implementation, an acceptable performance would yield the packet error rate (PER) of 1% or BER of 1.56×10⁻⁴. As disclosed in the graph of FIG. 6, BER of 1.56×10⁻⁴ is achievable with SNR of about 3.2 dB for K=9, 3.5 dB for K=7, 4.7 dB for K=4, and 8.5 dB for the uncoded.

The foregoing description and claims may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the figures depict example arrangements of elements and components, additional intervening elements, devices, features, or components may be present in an actual embodiment (assuming that the functionality of the depicted circuits is not adversely affected).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. When implemented in software or firmware, the functions may be stored on or transmitted over as one or more instructions or code on a tangible, non-transitory computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, flash, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Thus, in some aspects, computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

### APPLICATIONS

Furthermore, the disclosed transmission methods, systems, and/or apparatus can be implemented into various electronic devices. Examples of the electronic devices can include, but are not limited to, consumer electronic products, parts of the consumer electronic products, electronic test equipment, etc. Examples of the electronic devices can also include memory chips, memory modules, circuits of optical networks or other communication networks, and disk driver circuits. The consumer electronic products can include, but are not limited to, wireless devices, a mobile phone, cellular base stations, a telephone, a television, a computer monitor, a computer, a hand-held computer, a personal digital assistant (PDA), a microwave, a refrigerator, a stereo system, a cassette recorder or player, a DVD player, a CD player, a VCR, an MP3 player, a radio, a camcorder, a camera, a digital camera, a portable memory chip, a washer, a dryer, a washer/dryer, a copier, a facsimile machine, a scanner, a multi-functional peripheral device, a wrist watch, a clock, etc. Further, the electronic device can include unfinished products.

It is to be understood that the implementations are not limited to the precise configuration and components illustrated above. Various modifications, changes and variations may be made in the arrangement, operation and details of the methods and apparatus described above without departing from the scope of the implementations.

Although this invention has been described in terms of certain embodiments, other embodiments that are apparent to those of ordinary skill in the art, including embodiments that do not provide all of the features and advantages set forth herein, are also within the scope of this invention. Moreover, the various embodiments described above can be combined to provide further embodiments. In addition, certain features shown in the context of one embodiment can be incorporated into other embodiments as well.

1. An apparatus comprising:
a serial-to-parallel converter configured to allocate symbols of a first signal among a plurality of parallel signals; and
a long-range spreader configured to generate a long-range spread signal from the plurality of parallel signals, the signals carrying payload data,
wherein the long-range spreader is-extends the plurality of parallel signals with a plurality of direct sequence spread spectrum (DSSS) encoders extended by a plurality of orthogonal vectors of an orthogonal transform.

2. The apparatus of claim 1, wherein the number of the plurality of parallel signals and the size of the orthogonal transform are selected to increase signal sensitivity.

3. The apparatus of claim 1, further comprising a forward error correction module configured to apply forward error correction and/or interleaving to an input signal to generate the first signal.

4. The apparatus of claim 1, further comprising a modulator configured to apply offset quadrature phase-shift keying (O-QPSK) to the output from the long-range spreader.

5. The apparatus of claim 1, wherein the orthogonal transform comprises a Hadamard transform.

6. The apparatus of claim 1, wherein each DSSS encoder comprises an (N,1)-DSSS encoder.

7. The apparatus of claim 1, further comprising an independently selectable parallel DSSS path not including the serial-to-parallel converter and/or the long-range spreader.

8. The apparatus of claim 1, further comprising an independently selectable parallel multiplexed DSSS (MDSSS) path not including the serial to parallel converter and/or the long-range spreader.

9. The apparatus of claim 1, further comprising a transmitter configured to transmit a signal including a modulated version of the long-range spreader output.

10. An electronically-implemented method of signal processing, the method comprising:
allocating symbols of a first signal among a plurality of parallel signals;
direct sequence spreading the plurality of parallel signals, the signals carrying payload data, to generate a plurality of spread signals; and
orthogonalizing the plurality of spread signals with a plurality of orthogonal vectors of an orthogonal transform to generate an orthogonalized output.

11. The method of claim 10, further applying forward error correction and/or interleaving to an input signal to generate the first signal.

12. The method of claim 10, further comprising applying offset quadrature phase-shift keying (O-QPSK) to the orthogonalized output.

13. The method of claim 10, wherein orthogonalizing comprises applying a Hadamard transform.

14. The method of claim 10, wherein direct sequence spreading comprises applying (N,1)-DSSS mapping.

15. The method of claim 10, further comprising performing direct sequence spreading along a parallel DSSS path not including a serial to parallel converter and/or an orthogonal transformer.

16. The method of claim 10, further comprising performing multiplexed direct sequence spreading along a parallel MDSSS path not including a serial to parallel converter and/or an orthogonal transformer.

17. The method of claim 10, further comprising transmitting a signal including a modulated version of the orthogonalized output.

18. An apparatus for signal processing, the apparatus comprising:
a serial-to-parallel converter configured to allocate symbols of a first signal among a plurality of parallel signals;
a plurality of direct sequence spread spectrum (DSSS) encoders configured to generate a plurality of spread signals in parallel from the plurality of parallel signals, the signals carrying payload data; and
a means for orthogonalizing the plurality of spread signals with a plurality of orthogonal vectors of an orthogonal transform to generate an orthogonalized output.

19. The apparatus of claim 18, further comprising an independently selectable parallel DSSS path not including the serial-to-parallel converter and/or the signal processor.

20. The apparatus of claim 1, wherein the bitrate of the long-range spread signal is based in part on the number of the plurality of DSSS encoders extended by the plurality of orthogonal vectors of an orthogonal transform.
